(19) United States
(12) Patent Application Publication
(10) Pub. No.: US 2026/0121528 A1
(43) Pub. Date: Apr. 30, 2026

(54) RESONANT POWER CONVERSION CIRCUIT AND DRIVING METHOD THEREOF FOR ELIMINATING AUDIO NOISE

(71) Applicant: Richtek Technology Corporation, Zhubei City (TW)

(72) Inventors: Ta-Yung YANG, Taoyuan City (TW); Kuo-Chi LIU, Hsinchu City (TW); Tzu-Chen LIN, Zhubei City (TW)

(21) Appl. No.: 19/297,131

(22) Filed: Aug. 12, 2025

Related U.S. Application Data
(60) Provisional application No. 63/713,612, filed on Oct. 30, 2024.

(30) Foreign Application Priority Data
Jun. 13, 2025 (TW) 114122219

(51) Int. Cl. H02M 3/00; H02M 1/00; H02M 3/335

(52) U.S. Cl. CPC H02M 3/01; H02M 1/0009; H02M 1/0035; H02M 3/33569

(57) ABSTRACT

A resonant power conversion circuit includes a resonant capacitor, a transformer, a high-side transistor, a low-side transistor, and a control circuit. The resonant capacitor is coupled between a resonant node and the ground. The transformer includes a primary coil coupled between a switch node and the resonant node. The high-side transistor provides an input voltage to the switch node. The low-side transistor couples the switch node to the ground. When the control circuit determines that the frequency driving the high-side transistor and the low-side transistor is in a frequency range, the control circuit turns off both the high-side transistor and the low-side transistor for a delay time to shift the driving frequency outside the frequency range.

### CROSS REFERENCE TO RELATED APPLICATIONS

This application claims the benefit of U.S. Provisional Application No. 63/713,612, filed on Oct. 30, 2024, the entirety of which is incorporated by reference herein.

This application claims priority of Taiwan Patent Application No. 114122219, filed on Jun. 13, 2025, the entirety of which is incorporated by reference herein.

### BACKGROUND OF THE INVENTION

### Field of the Invention

The disclosure is generally related to a resonant power conversion circuit and a driving method thereof, and more particularly it is related to a resonant power conversion circuit and a driving method thereof for eliminating audio noise.

### Description of the Related Art

With the ongoing development of portable electronic devices, the trends in power conversion circuits (like most power products) have been toward high efficiency, high power density, high reliability, and low cost. Resonant power conversion circuits (including LLC resonant power conversion circuit, etc.) have advantages that include zero-voltage switching (ZVS) on the primary side and zero-current switching (ZCS) of the rectifier diode on the secondary side within the full load range. Frequency control is used to make the duty cycle of the high-side and low-side transistors both 50% with no output inductor required. Lower voltage transistors can be used on the secondary side to reduce costs and also to improve efficiency, and they have been increasingly used in DC voltage converters in recent years.

When a resonant power converter circuit operates in a low-load state, it often enters a burst mode to reduce power loss in the low-load state. However, when the resonant power converter circuit operates in the burst mode, the switching frequency driving the high-side transistor and the low-side transistor may fall into the audio range, thereby generating disturbing noise. Therefore, it is necessary to improve the operations of the resonant power converter circuit in the burst mode.

### BRIEF SUMMARY OF THE INVENTION

The present invention proposes a resonant power converter circuit and a driving method thereof, which determines whether the burst frequency of the resonant power conversion circuit enters the audio range by monitoring a mapping voltage related to the feedback voltage. When it is determined that the burst frequency of the resonant power conversion circuit enters the audio range, the duration that both the high-side transistor and the low-side transistor are turned off is extended, so that the driving frequency leaves the audio range, thereby eliminating the noise generated by the resonant power conversion circuit.

In an embodiment, a resonant power conversion circuit converting an input voltage into an output voltage is provided. The resonant power conversion circuit comprises a resonant capacitor, a transformer, a high-side transistor, a low-side transistor, and a control circuit. The resonant capacitor is coupled between a resonant node and a ground. The transformer comprises a primary coil and a secondary coil, where the primary coil is coupled between a switch node and the resonant node. The high-side transistor provides the input voltage to the switch node based on a high-side driving signal. The low-side transistor couples the switch node to the ground based on a low-side driving signal. The control circuit generates the high-side driving signal and the low-side driving signal based on the output voltage. When the control circuit determines that a driving frequency of either the high-side driving signal or the low-side driving signal enters a frequency range, the control circuit simultaneously turns off both the high-side transistor and the low-side transistor for a delay time, so as to shift the driving frequency outside the frequency range.

According to an embodiment of the present invention, the resonant power conversion circuit further comprises a feedback circuit. The feedback circuit generates a feedback voltage based on the output voltage. The control circuit further comprises a compensation circuit. The compensation circuit generates a compensation voltage based on the feedback voltage and subtracting a sawtooth wave from the compensation voltage to generate a compensation signal. When the feedback voltage is less than a feedback threshold voltage, the compensation voltage is equal to the feedback threshold voltage. When the feedback voltage is not less than the feedback threshold voltage, the compensation voltage is equal to the feedback voltage.

According to an embodiment of the present invention, the compensation circuit further comprises a first amplifier, a second amplifier, a resistor, an N-type transistor, a digital circuit, a current mirror, and a summing circuit. The first amplifier comprises a first positive input terminal, a first negative input terminal, and a first output terminal, wherein the first positive input terminal receives the feedback voltage, and the first negative input terminal is coupled to the first output terminal. The second amplifier comprises a second positive input terminal, a second negative input terminal, and a second output terminal, where the second positive input terminal receives the feedback threshold voltage, and the second output terminal generates the compensation voltage. The resistor is coupled between the second negative input terminal and the first output terminal and generates a difference current. The N-type transistor comprises a gate terminal, a drain terminal, and a source terminal, where the gate terminal is coupled to the second output terminal, and the source terminal is coupled to the second negative input terminal. The digital circuit sinks a circulating current from the drain terminal. The current mirror mirrors a sum of the difference current and the circulating current to a mapping current. The summing circuit subtracts the sawtooth wave from the compensation voltage to generate the compensation signal.

According to an embodiment of the present invention, the resonant power conversion circuit further comprises a first current detection circuit, an integrator, a full-wave rectification device, and a regulation circuit. The first current detection circuit detects a current flowing through the resonant capacitor to generate a current detection signal. The integrator integrates the current detection signal to generate an integral signal. The full-wave rectification device full-wave rectifies the integral signal generated by the integrator to generate a rectified signal. The regulation circuit is coupled to the secondary coil and converts a current flowing through the secondary coil into the output voltage. The control circuit generates the high-side driving signal and the low-side driving signal based on a relationship between the compensation signal and the rectified signal.

According to an embodiment of the present invention, the control circuit further comprises an output voltage detection circuit. The output voltage detection circuit determines whether the feedback voltage is less than a low-power threshold voltage to generate a pre-burst signal. When the feedback voltage is less than the low-power threshold voltage, the output voltage detection circuit enables the pre-burst signal. When the feedback voltage is not less than the low-power threshold voltage, the output voltage detection circuit disables the pre-burst signal.

According to an embodiment of the present invention, the control circuit simultaneously disables both the high-side driving signal and the low-side driving signal based on the pre-burst signal being enabled, so as to lower the driving frequency. The control circuit enables the high-side driving signal and the low-side driving signal individually based on the pre-burst signal being disabled.

According to an embodiment of the present invention, when the feedback voltage is less than the low-power threshold voltage, the output voltage detection circuit further determines whether the driving frequency enters the frequency range. When the driving frequency enters the frequency range, the control circuit enables a cyclic signal to simultaneously turn off both the high-side transistor and the low-side transistor for an audio-frequency delay time. After the audio-frequency delay time, the control circuit enables the high-side driving signal and the low-side driving signal each at least once.

According to an embodiment of the present invention, the frequency range is a range of audio frequencies. The audio-frequency delay time is not less than the maximum of inverses of the audio frequencies.

According to an embodiment of the present invention, the compensation circuit generates a mapping voltage based on a difference of the feedback threshold voltage minus the feedback voltage. The output voltage detection circuit determines, based on the mapping voltage being between a first audio voltage and a second audio voltage, that the driving frequency enters the frequency range. The mapping voltage is configured to determine a duration that the pre-burst signal is enabled.

According to an embodiment of the present invention, the compensation circuit increases the mapping voltage based on a number of times that the cyclic signal is enabled, so as to extend the duration that the pre-burst signal is enabled.

In another embodiment, a driving method for driving a resonant power conversion circuit is provided. The driving method comprises the following steps. A high-side transistor and a low-side transistor of the resonant power conversion circuit are driven based on a voltage across a resonant capacitor and an output voltage of the resonant power conversion circuit. It is determined whether the output voltage of the resonant power conversion circuit is too high. When it is determined that the output voltage is too high, a burst mode is entered. It is determined whether a driving frequency of the resonant power conversion circuit falls into an audio range. When it is determined that the driving frequency falls into the audio range, a duration of the burst mode is extended.

According to an embodiment of the present invention, the resonant power conversion circuit comprises a resonant capacitor, a transformer, a high-side transistor, and the low-side transistor. The resonant capacitor is coupled between a resonant node and the ground. The transformer comprises a primary coil and a secondary coil. The high-side transistor provides an input voltage to a switch node. The low-side transistor couples the switch node to the ground. The primary coil is coupled between the switch node and the resonant node.

According to an embodiment of the present invention, the step of driving the high-side transistor and the low-side transistor of the resonant power conversion circuit based on the voltage across the resonant capacitor and the output voltage of the resonant power conversion circuit further comprises the following steps. The voltage across the resonant capacitor is full-wave rectified to generate a rectified signal. A compensation voltage is generated based on the feedback voltage. A sawtooth wave is subtracted from the compensation voltage to generate a compensation signal. The rectified signal is compared to the compensation signal to drive the high-side transistor and the low-side transistor. When the feedback voltage is less than a feedback threshold voltage, the compensation voltage is equal to the feedback threshold voltage. When the feedback voltage is not less than the feedback threshold voltage, the compensation voltage is equal to the feedback voltage.

According to an embodiment of the present invention, the step of full-wave rectifying the voltage across the resonant capacitor to generate a rectified signal further comprises the following steps. A current flowing through the resonant capacitor is detected to generate a current detection signal. The current detection signal is integrated to generate an integral signal. The integral signal is full-wave rectified to generate the rectified signal.

According to an embodiment of the present invention, the step of determining whether the output voltage of the resonant power conversion circuit is too high further comprises the following steps. It is determined whether the feedback is less than a low-power threshold voltage. When the feedback voltage is less than the low-power threshold voltage, the burst mode is entered. When the feedback voltage is not less than the low-power threshold voltage, the burst mode is not entered. Both the high-side transistor and the low-side transistor are turned off simultaneously in the burst mode.

According to an embodiment of the present invention, the step of determining whether the driving frequency of the resonant power conversion circuit falls into the audio range further comprises the following steps. A mapping voltage is generated based on the feedback voltage. It is determined whether the mapping voltage is between a first audio voltage and a second audio voltage. When the mapping voltage is between the first audio voltage and the second audio voltage, it is determined that the driving frequency of the resonant power conversion circuit falls into the audio range. When the mapping voltage is outside the first audio voltage and the second audio voltage, it is determined that the driving frequency of the resonant power conversion circuit does not fall into the audio range.

According to an embodiment of the present invention, the step of generating the mapping voltage based on the feedback voltage further comprises the following steps. A difference current is generated based on a difference of the feedback threshold voltage minus the feedback voltage. The difference current is mapped to a mapping current using a current mirror. The mapping voltage is generated by the mapping current flowing through a resistor.

According to an embodiment of the present invention, when it is determined that the driving frequency falls into the audio range, the duration of the burst mode is extended to an audio-frequency delay time. After the audio-frequency delay time, turning on the high-side transistor and the low-side transistor each at least once.

According to an embodiment of the present invention, the audio-frequency delay time is not less than a maximum of inverses of audio frequencies.

According to an embodiment of the present invention, the driving method further comprises the following steps. Based on the duration of a pre-burst signal being enabled, the number of times that the burst mode and a cyclic signal have been enabled is determined. The number of times that the cyclic signal has been enabled is counted. The duration of the pre-burst signal being enabled is extended, based on the number of times that the cyclic signal has been enabled.

A detailed description is given in the following embodiments with reference to the accompanying drawings.

### BRIEF DESCRIPTION OF DRAWINGS

The invention can be more fully understood by reading the subsequent detailed description and examples with references made to the accompanying drawings, wherein:

FIG. 1 is a block diagram showing a resonant power conversion circuit in accordance with an embodiment of the present invention;

FIG. 2 is a block diagram showing a full-wave rectification device a in accordance with an embodiment of the present invention;

FIG. 3 is a waveform diagram showing the rectified signal and the integral signal in accordance with an embodiment of the present invention;

FIG. 4 is a block diagram showing a compensation circuit in accordance with an embodiment of the present invention;

FIG. 5 is a block diagram showing a control circuit in accordance with an embodiment of the present invention;

FIG. 6 is a waveform diagram showing a control circuit in accordance with an embodiment of the present invention;

FIG. 7 is a circuit diagram showing a delay time generator in accordance with an embodiment of the present invention;

FIG. 8 shows waveforms of a resonant power conversion circuit operating in light load in accordance with an embodiment of the present invention;

FIG. 9 shows a relationship between a feedback voltage and a driving frequency in accordance with an embodiment of the present invention;

FIG. 10 shows a circuit diagram of an output voltage detection circuit in accordance with an embodiment of the present invention;

FIG. 11 shows a circuit diagram of a single-cycle circuit in accordance with an embodiment of the present invention;

FIG. 12 shows a circuit diagram of a delay circuit in accordance with an embodiment of the present invention;

FIG. 13 shows waveforms of a resonant power conversion circuit operating in light load in accordance with another embodiment of the present invention; and

FIG. 14 shows a flow chart of a driving method in accordance with an embodiment of the present invention.

### DETAILED DESCRIPTION OF THE INVENTION

The following description is made for the purpose of illustrating the general principles of the disclosure and should not be taken in a limiting sense. The scope of the disclosure is determined by reference to the appended claims.

In the following detailed description, for purposes of explanation, numerous specific details and embodiments are set forth in order to provide a thorough understanding of the present disclosure. The use of like and/or corresponding numerals in the drawings of different embodiments does not suggest any correlation between different embodiments.

In addition, in some embodiments of the present disclosure, terms concerning attachments, coupling and the like, such as “connected” and “interconnected,” refer to a relationship wherein structures are secured or attached to one another either directly or indirectly (for example, electrically connection) via intervening structures, as well as both movable or rigid attachments or relationships, unless expressly described otherwise.

In addition, in this specification, relative spatial expressions are used. For example, “lower”, “bottom”, “higher” or “top” are used to describe the position of one element relative to another. It should be appreciated that if a device is flipped upside down, an element that is “lower” will become an element that is “higher”.

It should be understood that, although the terms first, second, third etc. may be used herein to describe various elements, components, regions, layers, portions and/or sections, these elements, components, regions, layers, portions and/or sections should not be limited by these terms. These terms are only used to distinguish one element, component, region, layer, portion or section from another element, component, region, layer or section. Thus, a first element, component, region, layer, portion or section in the specification could be termed a second element, component, region, layer, portion or section in the claims without departing from the teachings of the present disclosure.

It should be understood that this description of the exemplary embodiments is intended to be read in connection with the accompanying drawings, which are to be considered part of the entire written description. The drawings are not drawn to scale. In addition, structures and devices are shown schematically in order to simplify the drawing.

The terms “approximately”, “about” and “substantially” typically mean a value is within a range of +/−20% of the stated value, more typically a range of +/−10%, +/−5%, +/−3%, +/−2%, +/−1% or +/−0.5% of the stated value. The stated value of the present disclosure is an approximate value. Even there is no specific description, the stated value still includes the meaning of “approximately”, “about” or “substantially”.

Unless defined otherwise, all technical and scientific terms used herein have the same meaning as commonly understood by one of ordinary skill in the art to which this disclosure belongs. It should be appreciated that, in each case, the term, which is defined in a commonly used dictionary, should be interpreted as having a meaning that conforms to the relative skills of the present disclosure and the background or the context of the present disclosure, and should not be interpreted in an idealized or overly formal manner unless so defined.

In addition, in some embodiments of the present disclosure, terms concerning attachments, coupling and the like, such as “connected” and “interconnected,” refer to a relationship wherein structures are secured or attached to one another either directly or indirectly (for example, electrically connection) via intervening structures, as well as both movable or rigid attachments or relationships, unless expressly described otherwise.

In the drawings, similar elements and/or features may have the same reference number. Various components of the same type can be distinguished by adding letters or numbers after the component symbol to distinguish similar components and/or similar features.

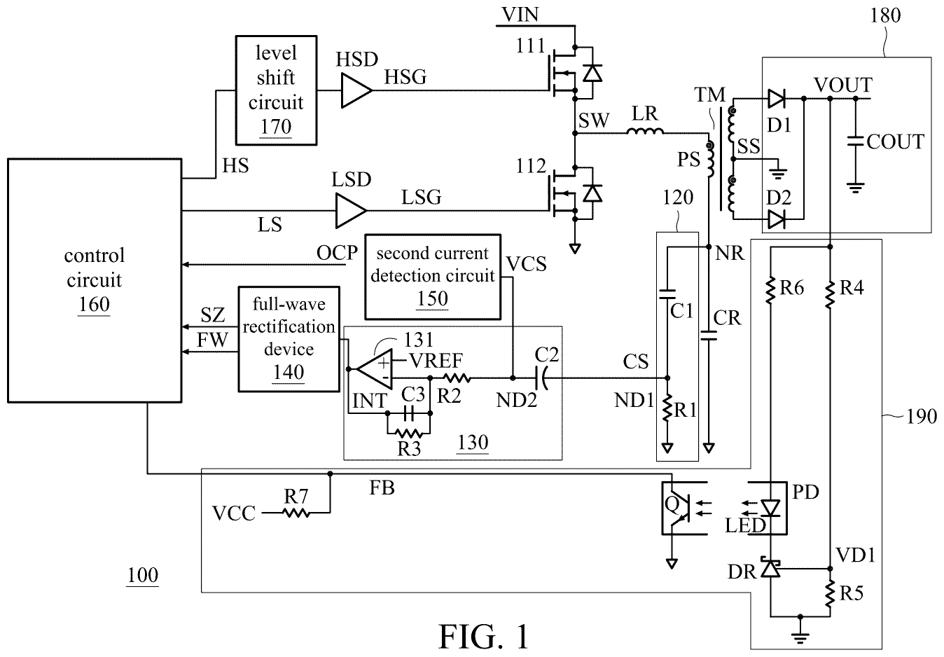

FIG. 1 is a block diagram showing a resonant power conversion circuit in accordance with an embodiment of the present invention. As shown in FIG. 1, the resonant power conversion circuit 100 includes a transformer TM, a resonant inductor LR, a resonant capacitor CR, an high-side transistor 111, a low-side transistor 112, a first current detection circuit 120, an integrator 130, a full-wave rectification device 140, a second current detection circuit 150, a control circuit 160, a level shift circuit 170, a high-side driving circuit HSD, a low-side driving circuit LSD, a regulation circuit 180, and a feedback circuit 190.

The transformer TM includes a primary coil PS and a secondary coil SS, where the primary coil PS is coupled to the resonant node NR. The resonant inductor LR is coupled between the switch node SW and the primary coil PS, and the resonant capacitor CR is coupled between the resonant node NR and the ground. According to an embodiment of the present invention, the resonant inductor LR can be replaced by the leakage inductance of the primary coil PS of the transformer TM. In other words, the primary coil PS may be coupled between the switch node SW and the resonant node NR.

The high-side gate driving signal HSG drives the high-side transistor 111 to be conductive or non-conductive, thereby providing the input voltage VIN to the switch node SW. The low-side gate driving signal LSG drives the low-side transistor 112 to be conductive or non-conductive, thereby coupling the switch node SW to the ground. The first current detection circuit 120 includes a first capacitor C1 and a first resistor R1. The first capacitor C1 is coupled between the resonant node NR and the first detection node ND1. The first resistor R1 is coupled between the first detection node ND1 and the ground. According to an embodiment of the present invention, the first current detection circuit 120 is configured to detect a current flowing through the resonant capacitor CR to generate the current detection signal CS at the first detection node ND1.

The integrator 130 is configured to integrate the current detection signal CS of the first detection node ND1 to generate an integral signal INT. As shown in FIG. 1, the integrator 130 includes a second capacitor C2, a second resistor R2, an integrating amplifier 131, a third resistor R3, and a third capacitor C3. The second capacitor C2 is coupled between the first detection node ND1 and the second detection node ND2, and the second resistor R2 is coupled between the second detection node ND2 and the negative input terminal of the integrating amplifier 131.

According to some embodiment of the present invention, the second capacitor C2 is configured to block DC part of the current detection signal CS. The positive input terminal of the integrating amplifier 131 receives the reference voltage VREF, and the third resistor R3 and the third capacitor C3 are connected in parallel between the output terminal and the negative input terminal of the integrating amplifier 131.

The full-wave rectification device 140 full-wave rectifies the integral signal INT to generate the rectified signal FW and the crossover signal SZ. The second current detection circuit 150 is coupled to the second detection node ND2 and generates an over-current signal OCP according to the current detection voltage VCS of the second detection node ND2.

The control circuit 160 generates a high-side driving signal HS and a low-side driving signal LS based on the rectified signal FW, the feedback voltage FB, and the over-current signal OCP. The level shift circuit 170 is used to convert the high-side driving signal HS to the voltage level of the input voltage VIN to generate the high-side gate driving signal HSG through the high-side driving circuit HSD to drive the high-side transistor 111. The low-side driving circuit LSD generates the low-side gate driving signal LSG based on the low-side driving signal LS to drive the low-side transistor 112.

The regulation circuit 180 is coupled to the secondary coil SS and used to convert the current flowing through the secondary coil SS into the output voltage VOUT. As shown in FIG. 1, the regulation circuit 180 includes a first regulation element D1, a second regulation element D2 and an output capacitor COUT. The first regulation element D1 and the second regulation element D2 are used to more efficiently charge the output capacitor COUT with the current flowing through the secondary coil SS, thereby generating the output voltage VOUT. According to other embodiments of the present invention, the first regulation element D1 and the second regulation element D2 can be replaced with electronic components with low on-resistance to further improve the conversion efficiency.

The feedback circuit 190 generates a feedback voltage FB based on the output voltage VOUT. As shown in FIG. 1, the feedback circuit 190 includes a fourth resistor R4, a fifth resistor R5, a voltage stabilizing element DR, an optical coupling element PD, a sixth resistor R6, and a seventh resistor R7. The fourth resistor R4 and the fifth resistor R5 are configured to divide the output voltage VOUT to generate the first divided voltage VD1. Based on the first divided voltage VD1, the voltage stabilizing element DR generates a current flowing through the diode LED of the optical coupling element PD to cause the diode LED to emit light, and turns on the transistor Q of the optical coupling element PD through optical coupling.

The sixth resistor R6 is configured to limit the current flowing through the diode LED. The supply voltage VCC generates a feedback voltage FB through the seventh resistor R7 and the turned-on transistor Q. According to an embodiment of the present invention, the voltage stabilizing component DR may be TL431. According to some embodiments of the present invention, when the output voltage VOUT increases, the feedback voltage FB decreases accordingly.

According to other embodiments of the present invention, when the output voltage VOUT decreases, the feedback voltage FB increases accordingly. According to other embodiments of the present invention, when the output power of the output voltage VOUT increases, the feedback voltage FB increases accordingly. When the output power of the output voltage VOUT decreases, the feedback voltage FB decreases accordingly. The control method of the resonant power conversion circuit 100 will be described in detail in the following paragraphs.

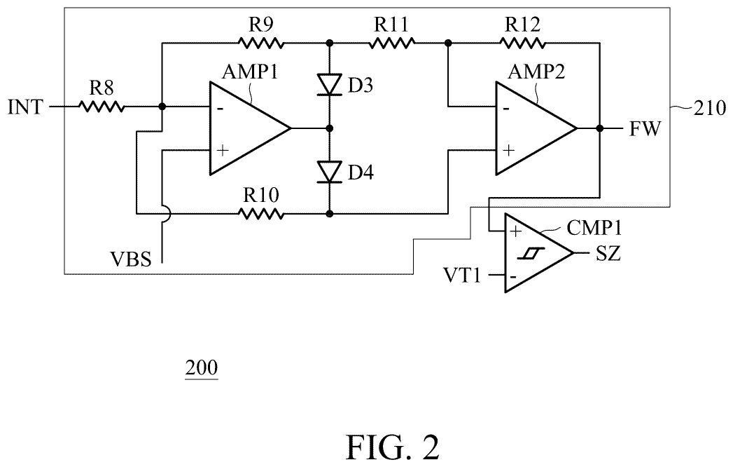

FIG. 2 is a block diagram showing a full-wave rectification device a in accordance with an embodiment of the present invention. According to an embodiment of the present invention, the full-wave rectification device 200 in FIG. 2 corresponds to the full-wave rectification device 140 in FIG. 1. As shown in FIG. 2, the full-wave rectification device 200 includes a full-wave rectification device 210 and a first comparator CMP1. The full-wave rectification device 210 includes an eighth resistor R8, a ninth resistor R9, a tenth resistor R10, a first amplifier AMP1, an eleventh resistor R11, a twelfth resistor R12, a third diode D3, a fourth diode D4, and a second amplifier AMP2. The full-wave rectification device 210 uses the basic voltage VBS as the DC level to perform full-wave rectification on the integral signal INT generated by the integrator 130 to generate the rectified signal FW.

The first comparator CMP1 compares the rectified signal FW with the first threshold voltage VT1 to generate a crossover signal SZ. According to an embodiment of the present invention, the first threshold voltage VT1 is slightly higher than the basic voltage VBS. According to an embodiment of the present invention, when the rectified signal FW is less than the first threshold voltage VT1, the first comparator CMP1 sets the crossover signal SZ to the disabled state. According to another embodiment of the present invention, when the rectified signal FW exceeds the first threshold voltage VT1, the first comparator CMP1 sets the crossover signal SZ to the enabled state.

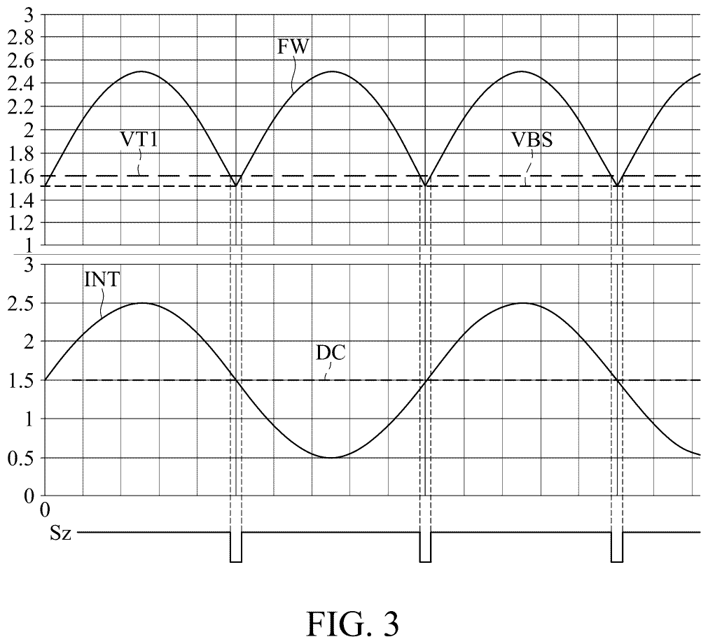

FIG. 3 is a waveform diagram showing the rectified signal and the integral signal in accordance with an embodiment of the present invention. As shown in FIG. 3, the integral signal INT has a DC level DC, and the full-wave rectification device 210 uses the basic voltage VBS as the DC level to perform full-wave rectification on the integral signal INT to generate the rectified signal FW. Then, the first comparator CMP1 compares the rectified signal FW with the first threshold voltage VT1 to generate the crossover signal SZ. As shown in FIG. 3, when the rectified signal FW is less than the first threshold voltage VT1, the first comparator CMP1 disables the cross signal SZ. When the rectified signal FW is not less than the first threshold voltage VT1, the cross signal SZ is kept in the enabled state.

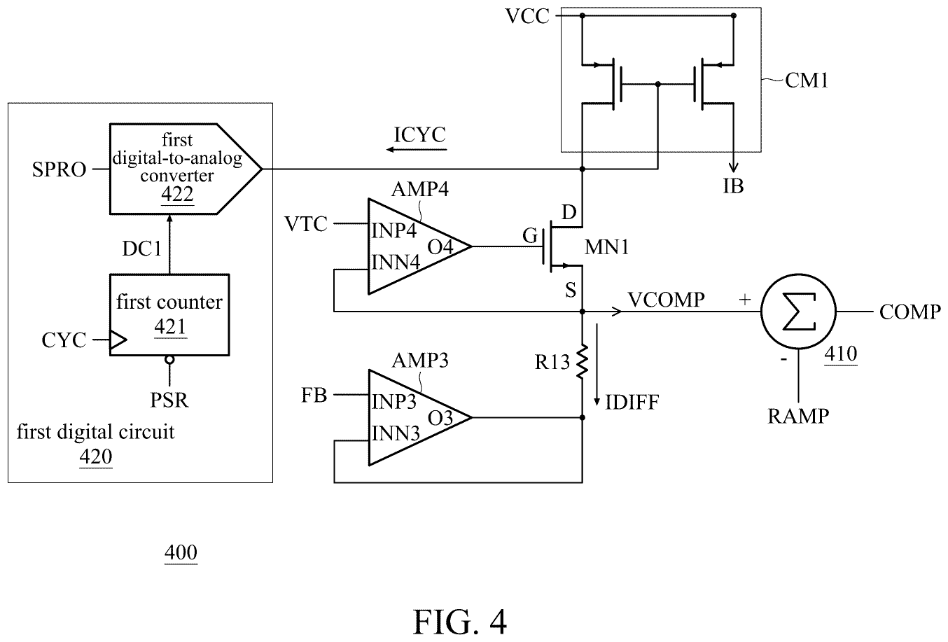

FIG. 4 is a block diagram showing a compensation circuit in accordance with an embodiment of the present invention. According to an embodiment of the present invention, the control circuit 160 in FIG. 1 includes a compensation circuit 400. As shown in FIG. 4, the compensation circuit 400 includes a third amplifier AMP3, a fourth amplifier AMP4, a thirteenth resistor R13, a first N-type transistor MN1, a summing circuit 410, a first current mirror CM1, and a first digital circuit 420.

The compensation circuit 400 is configured to generate the compensation voltage VCOMP based on the feedback voltage FB, and limit the compensation voltage VCOMP to not less than the feedback threshold voltage VTC. In other words, the compensation voltage VCOMP generated by the compensation circuit 400 is substantially equal to the feedback voltage FB, and the minimum value of the compensation voltage VCOMP is limited to the feedback threshold voltage VTC. In addition, the compensation circuit 400 further subtracts the sawtooth wave RAMP from the compensation voltage VCOMP to generate the compensation signal COMP.

The third amplifier AMP3 includes a third positive input terminal INP3, a third negative input terminal INN3, and a third output terminal O3, where the third positive input terminal INP3 receives a feedback voltage FB, and the third negative input terminal INN3 is coupled to the third output terminal O3. The fourth amplifier AMP4 includes a fourth positive input terminal INP4, a fourth negative input terminal INN4, and a fourth output terminal O4, wherein the fourth positive input terminal INP4 receives a feedback threshold voltage VTC. According to one embodiment of the present invention, the third amplifier AMP3 is coupled as a unity gain amplifier, so that the voltage of the third output terminal O3 is equal to the feedback voltage FB.

The thirteenth resistor R13 is coupled between the fourth negative input terminal INN4 and the third output terminal O3, and generates a difference current IDIFF. The first N-type transistor MN1 includes a gate terminal G, a drain terminal D, and a source terminal S, where the gate terminal G is coupled to the fourth output terminal O4, and the source terminal S is coupled to the fourth negative input terminal INN4 and generates a compensation voltage VCOMP. The summing circuit 410 is configured to subtract the sawtooth wave RAMP from the compensation voltage VCOMP to generate a compensation signal COMP. The first current mirror CM1 is coupled to the drain terminal D and maps the difference current IDIFF into a mapping current IB.

According to one embodiment of the present invention, when the feedback voltage FB is less than the feedback threshold voltage VTC, the thirteenth resistor R13 generates a difference current IDIFF based on the difference between the feedback threshold voltage VTC and the feedback voltage FB, and the first current mirror CM1 maps the difference current IDIFF into a mapping current IB. According to another embodiment of the present invention, when the feedback voltage FB is not less than the feedback threshold voltage VTC, the first N-type transistor MN1 is turned off, so that the first current mirror CM1 does not generate the mapping current IB.

As shown in FIG. 4, the first digital circuit 420 is configured to sink the circulating current ICYC from the drain terminal D of the first N-type transistor MN1 and includes a first counter 421 and a first digital-to-analog converter 422. The first counter 411 counts the signal edges of the cyclic signal CYC to generate a first digital code DC1 and resets the first digital code DC1 based on the pre-burst signal PSR being disabled.

The first digital-to-analog converter 412 adjusts the magnitude of the circulating current ICYC based on the first digital code DC1, so that the first current mirror CM1 adjusts the mirror current IB based on the magnitude of the circulating current ICYC. According to some embodiments of the present invention, the program signal SPRO is configured to adjust the resolution of the first digital-to-analog converter 422 and the magnitude of the circulating current ICYC. The effect of the circulating current ICYC increasing the mirror current IB will be described in the following paragraphs.

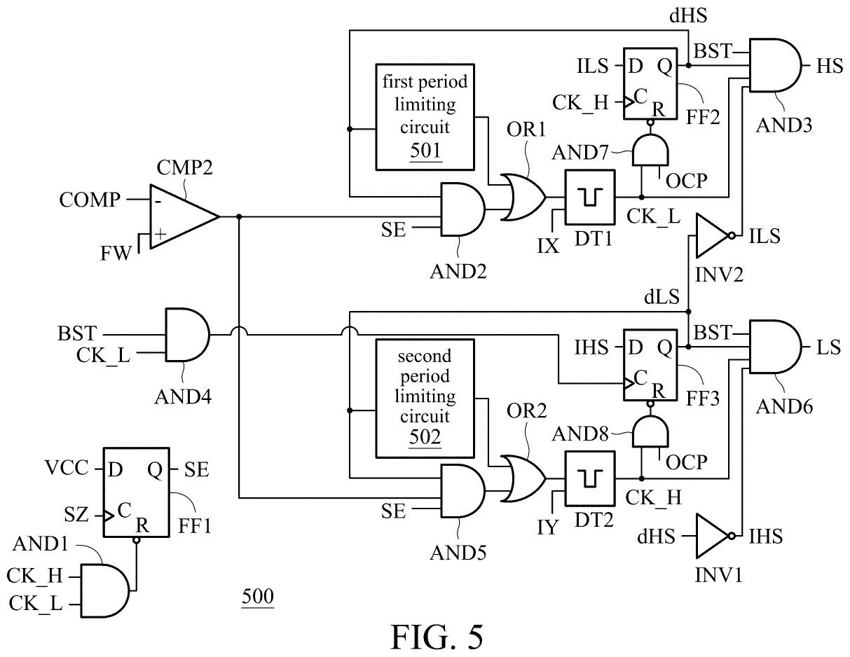

FIG. 5 is a block diagram showing a control circuit in accordance with an embodiment of the present invention. As shown in FIG. 5, the control circuit 500 includes a first flip-flop FF1 and a first AND gate AND1. The first flip-flop FF1 outputs the supply voltage VCC as the phase signal SE (that is, the phase signal SE is set to the enabled state) based on the positive signal edge of the crossover signal SZ (that is, the crossover signal SZ changes from the disabled state to the enabled state). According to some embodiments of the present invention, the crossover signal SZ at a low logic level is in a disabled state, and the crossover signal SZ at a high logic level is in an enabled state. In other words, as shown in FIG. 2, when the rectified signal FW increases to exceed the first threshold voltage VT1, the phase signal SE is enabled.

The first flip-flop FF1 further sets the phase signal SE to a disabled state based on the high-side dead time signal CK_H or the low-side dead time signal CK_L being in the disabled state (i.e., a low logic level). In other words, during the high-side dead time and the low-side dead time, the phase signal SE is in the disabled state. As shown in FIG. 5, the control circuit 500 further includes a second comparator CMP2, a second AND gate AND2, a first OR gate OR1, a first dead time generator DT1, a second flip-flop FF2, and a third AND gate AND3.

When the rectified signal FW exceeds the compensation voltage COMP generated by the compensation circuit 400, the delayed high-side driving signal dHS is in the enabled state, and the phase signal SE is in the enabled state, a negative pulse is generated on the low-side dead time signal CK_L by triggering the first dead time generator DT1 through the second AND gate AND2 and the first OR gate OR1, and the high-side driving signal HS is set to the disabled state through the third AND gate AND3, thereby turning off the high-side transistor 111 in FIG. 1.

In addition, the negative pulse of the low-side dead time signal CK_L resets the second flip-flop FF2, causing the delayed high-side driving signal dHS to be reset to the disabled state. According to an embodiment of the present invention, the width of the negative pulse of the low-side dead time signal CK_L is configured to determine the low-side dead time of the low-side transistor 112. According to an embodiment of the present invention, the first adjustment current IX is configured to adjust the length of the low-side dead time.

As shown in FIG. 5, the control circuit 500 further includes a first inverter INV1, a fourth AND gate AND4, a third flip-flop FF3, a fifth AND gate AND5, a second OR gate OR2, a second dead time generator DT2, and sixth AND gate AND6. The first inverter INV1 inverts the delayed high-side driving signal dHS in the disabled state and sets the initial high-side driving signal IHS to the enabled state. When the low-side dead time signal CK_L changes from the disabled state (negative pulse) to the enabled state and the burst signal BST is in the disabled state (the high logic level in the embodiment of FIG. 5), the third flip-flop FF3 outputs the initial high-side driving signal IHS in the enabled state as the delayed low-side driving signal dLS (that is, in the enabled state).

Then, when the delayed low-side driving signal dLS is in the enabled state, the rectified signal FW exceeds the compensation signal COMP, and the phase signal SE is in the enabled state, the second dead time generator DT2 is triggered to generate a negative pulse on the high-side dead time signal CK_H through the fifth AND gate AND5 and the second OR gate OR2, and the low-side driving signal LS is set to the disabled state through the sixth AND gate AND6, thereby turning off the low-side transistor 112 in FIG. 1. In addition, the negative pulse of the high-side dead time signal CK_H resets the third flip-flop FF3, causing the delayed low-side driving signal dLS to be in the disabled state. According to an embodiment of the present invention, the width of the negative pulse of the high-side dead time signal CK_H is configured to determine the high-side dead time of the high-side transistor 111. According to an embodiment of the present invention, the second adjustment current IY is configured to adjust the length of the high-side dead time.

As shown in FIG. 5, the control circuit 500 further includes a first period limiting circuit 501, a second period limiting circuit 502, and a second inverter INV2. When the enable period of the high-side driving signal HS exceeds the maximum enable period, the first period limit circuit 501 sends an enable signal to trigger the first dead time generator DT1 to generate a negative pulse to reset (or disable) the delayed high-side driving signal dHS, thereby disabling the high-side driving signal HS. According to an embodiment of the present invention, during the enable period of the high-side driving signal HS, the high-side transistor 111 is turned on; during the enable period of the low-side driving signal LS, the low-side transistor 112 is turned on.

When the enable period of the low-side driving signal LS exceeds the maximum enable period, the second period limit circuit 502 sends an enable signal to trigger the generation of the second dead time generator DT2 to generate a negative pulse to reset or disable the delayed low-side driving signal dLS, thereby disabling the low-side driving signal LS. The second inverter INV2 is used to invert the delayed low-side driving signal dLS to generate the initial low-side driving signal ILS.

As shown in FIG. 5, the control circuit 500 further includes a seventh AND gate AND7 and an eighth AND gate AND8. The seventh AND gate AND7 is used to perform a logical AND operation on the low-side dead time signal CK_L and the over-current signal OCP to reset the second flip-flop FF2. Specifically, when the low-side dead time signal CK_L is at a low logic level (i.e., negative pulse) or the over-current signal OCP is at a low logic level (i.e., negative pulse), the delayed high-side driving signal dHS is reset to the disabled state.

The eighth AND gate AND8 is used to perform a logical AND operation on the high-side dead time signal CK_H and the overcurrent signal OCP to reset the third flip-flop FF3. Specifically, when the high-side dead time signal CK_H is in a negative pulse state or the overcurrent signal OCP is in a negative pulse state, the delayed low-side driving signal dLS is reset to the disabled state.

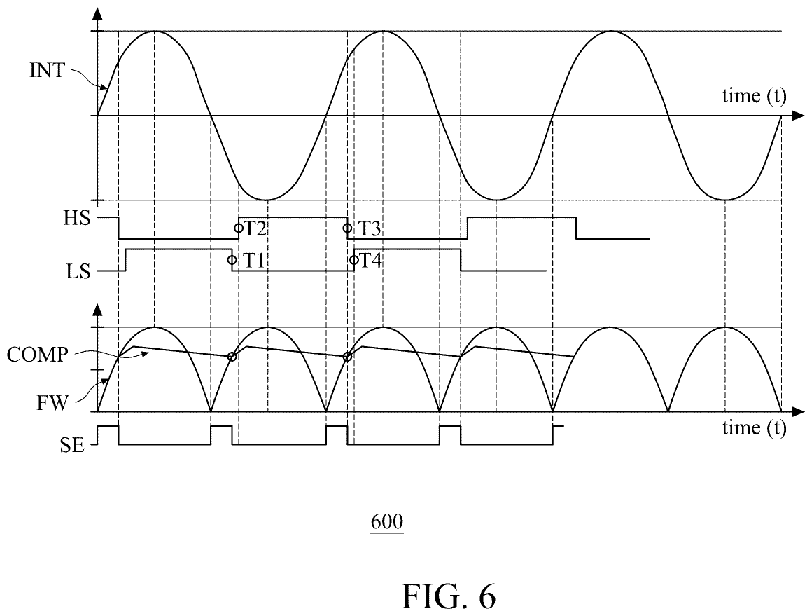

FIG. 6 is a waveform diagram showing a control circuit in accordance with an embodiment of the present invention. A detailed explanation will be described below in conjunction with the control circuit 500 in FIG. 5 and the waveform diagram 600 in FIG. 6.

At the first time point T1 in FIG. 6, the low-side driving signal LS is in the enabled state and the rectified signal FW keeps increasing to exceed the compensation signal COMP. As shown in FIG. 5, since the rectified signal FW exceeds the compensation signal COMP, the output of the second comparator CMP2 triggers the second dead time generator DT2 to generate a negative pulse on the high-side dead time signal CK_H through the fifth AND gate AND5 and the second OR gate OR2, and the negative pulse of the high-side dead time signal CK_H resets the first flip-flop FF1 and disables the phase signal SE. In addition, the negative pulse of the high-side dead time signal CK_H disables the low-side driving signal LS through the sixth AND gate AND6 at the same time.

According to an embodiment of the present invention, when the high-side dead time signal CK_H is in a disabled state, that is, between the first time point T1 and the second time point T2, the third flip-flop FF3 is reset to disable the delayed low-side driving signal dLS. Furthermore, the disabled delayed low-side driving signal dLS passes through the fifth AND gate AND5 and the second OR gate OR2 to stop the second dead time generator DT2 keeping disabling the high-side dead time signal CK_H, thereby ending the high-side dead time and going to the second time point T2.

At the second time point T2 in FIG. 6, the high-side dead time signal CK_H goes back to the enabled state from the negative pulse. That is, the high-side dead time signal CK_H generates a positive signal edge at the second time T2, so that the second flip-flop FF2 outputs the initial low-side driving signal ILS in the enabled state as the delayed high-side driving signal dHS, and sets the high-side driving signal HS to the enabled state through the third AND gate AND3.

At the third time point T3 in FIG. 6, the high-side driving signal HS continues to be in the enabled state, and the rectified signal FW continues to increase and just exceeds the compensation signal COMP. As shown in FIG. 5, since the rectified signal FW increases to exceed the compensation signal COMP, the output of the second comparator CMP2 triggers the first dead time generator DT1 through the second AND gate AND2 and the first OR gate OR1. The low-side dead time signal CK_L generates a negative pulse, and the negative pulse of the low-side dead time signal CK_L resets the first flip-flop FF1 and disables the phase signal SE. In addition, the negative pulse of the low-side dead time signal CK_L passes through the third AND gate AND3 to disable the high-side driving signal HS at the same time.

According to an embodiment of the present invention, when the low-side dead time signal CK_L is in the disabled state, the second flip-flop FF2 is reset to disable the delayed high-side driving signal dHS, and the disabled delayed high-side driving signal dHS passes through the second AND gate AND2 and the first OR gate OR1 to stop the first dead time generator DT1 keeping disabling the low-side dead time signal CK_L, so that the low-side dead time signal CK_L returns to the enabled state.

At the fourth time point T4 in FIG. 6, the low-side dead time signal CK_L returns to the enabled state from the negative pulse. That is, the low-side dead time signal CK_L generates a positive signal edge at the fourth time point T4, plus the burst signal BST is in the disabled state (i.e., the high logic level), so that the third flip-flop FF3 outputs the initial high-side driving signal IHS in the enabled state as the delayed low-side driving signal dLS, and sets the low-side driving signal LS to the enabled state through the sixth AND gate AND6.

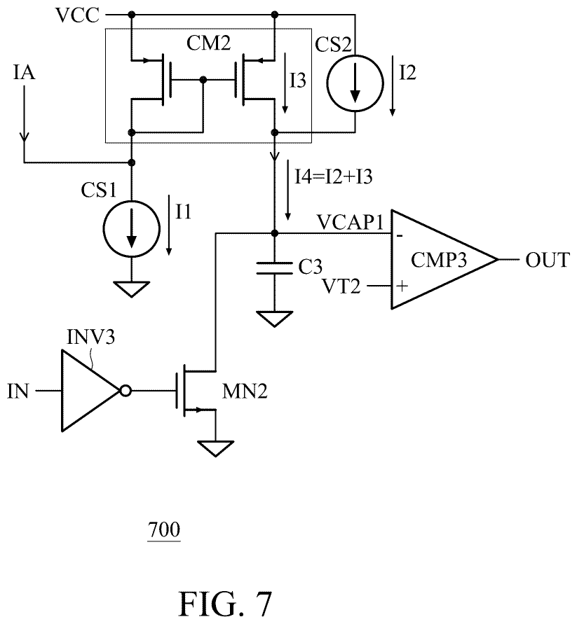

FIG. 7 is a circuit diagram showing a dead time generator in accordance with an embodiment of the present invention. According to an embodiment of the present invention, the delay time generator 700 in FIG. 7 corresponds to the first dead time generator DT1 and the second dead time generator DT2 in FIG. 5.

As shown in FIG. 7, the delay time generator 700 includes a third inverter INV3, a second N-type transistor MN2, a third capacitor C3, a first current source CS1, a second current mirror CM2, a second current source CS2, and a third comparator CMP3. When the input signal IN received by the third inverter INV3 is in a disabled state, the second N-type transistor MN2 is turned on to couple the first capacitor voltage VCAP1 generated by the third capacitor C3 to ground.

When the third inverter INV3 then receives the input signal IN in the enabled state, the second N-type transistor MN2 is turned off, and the second current mirror CM2 maps the first current I1 generated by the first current source CS1 to the third current I3. In addition, since the second current I2 generated by the second current source CS2 in parallel with the second current mirror CM2 is added, the third capacitor C3 is charged by the fourth current I4 to generate the first capacitor voltage VCAP1. According to an embodiment of the present invention, the fourth current I4 is the sum of the second current I2 and the third current I3.

When the first capacitor voltage VCAP1 exceeds the second threshold voltage VT2, the third comparator CMP3 generates an output signal OUT in a disabled state. When the input signal IN returns to the disabled state again, the second N-type transistor MN2 is turned on to discharge the first capacitor voltage VCAP1 to the ground, so that the output signal OUT generated by the third comparator CMP3 returns to the enabled state again. According to an embodiment of the present invention, the length of the charging time is determined based on the fourth current I4 and the capacitance value of the third capacitor C3.

According to an embodiment of the present invention, when the input current IA is additionally provided to the first current source CS1, the magnitude of the third current I3 is reduced, thereby reducing the fourth current I4 for charging the third capacitor C3. Therefore, the period of the output signal OUT remaining in the disabled state is extended. In other words, by increasing the magnitude of the input current IA, the duration of the negative pulse of the output signal OUT can be adjusted. According to some embodiments of the present invention, the input current IA in FIG. 7 corresponds to the first adjustment current IX and the second adjustment current IY in FIG. 5.

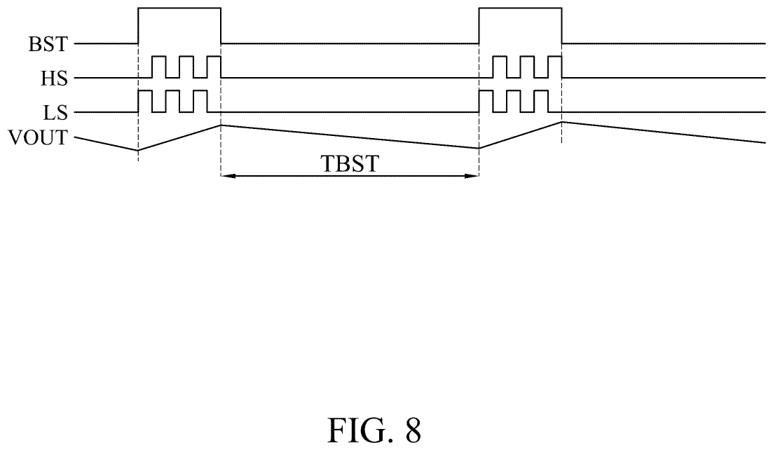

FIG. 8 shows waveforms of a resonant power conversion circuit operating in light load in accordance with an embodiment of the present invention. As shown in FIG. 8, when the burst signal BST is at a high logic level (i.e., disabled), the resonant power converter circuit 100 of FIG. 1 operates in a normal operation mode, and thus the high-side driving signal HS and the low-side driving signal LS are interleaved with each other to turn on the high-side transistor 111 and the low-side transistor 112, respectively.

When the output voltage VOUT continues to rise, causing the burst signal BST to transition to a low logic level (i.e., enabled), the resonant power converter circuit 100 operates in a burst mode, whereby both the high-side driving signal HS and the low-side driving signal LS remain in the disabled state to simultaneously turn off the high-side transistor 111 and the low-side transistor 112. In addition, the falling edge of the burst signal BST is aligned with the falling edge of the high-side driving signal HS, and the rising edge of the burst signal BST is aligned with the rising edge of the low-side driving signal LS. Furthermore, the low-side driving signal LS is enabled first and the high-side driving signal HS is then enabled.

According to some embodiments of the present invention, when the output power of the output voltage VOUT decreases, the output voltage VOUT continues to rise, causing the burst signal BST to transition to a low logic level (i.e., enabled), thereby operating the resonant power converter circuit 100 in the burst mode. In other words, when the output power of the output voltage VOUT decreases, both the high-side transistor 111 and the low-side transistor 112 of the resonant power converter circuit 100 are turned off, thereby reducing power loss and preventing the output voltage VOUT from being too high. However, the driving frequency of the high-side transistor 111 and the low-side transistor 112 may therefore enter the audio range, resulting in disturbing noise.

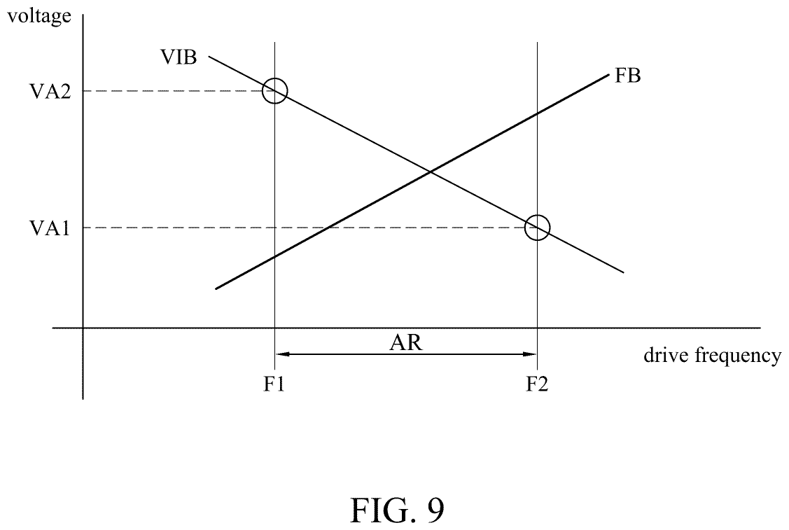

FIG. 9 shows a relationship between a feedback voltage and a driving frequency in accordance with an embodiment of the present invention. As shown in FIG. 9, when the output power of the output voltage VOUT of the resonant power conversion circuit 100 in FIG. 1 is too low, the feedback voltage FB is positively correlated with the driving frequency of the resonant power conversion circuit 100. The range from the first frequency F1 to the second frequency F2 is in the audio frequency range AR. According to some embodiments of the present invention, the first frequency F1 may be between 20 Hz and 200 Hz. According to some embodiments of the present invention, the second frequency F2 may be between 12 kHz and 20 kHz. According to some embodiments of the present invention, the driving frequency of the resonant power conversion circuit 100 shown in FIG. 9 may also be referred to as a burst frequency.

The mapping voltage VIB in FIG. 9 is generated by the mapping current IB in FIG. 4 flowing through a resistor. In addition, as shown in FIG. 4, the lower the feedback voltage FB is, the greater the difference current IDIFF is, thereby increasing the mapping current IB. In other words, the mapping current IB is negatively correlated with the feedback voltage FB, and the mapping voltage VIB is also negatively correlated with the feedback voltage FB.

As shown in FIG. 9, the mapping voltage VIB intersects the second frequency F2 at the first audio voltage VA1 and intersects the first frequency F1 at the second audio voltage VA2. In other words, when the mapping voltage VIB is between the first audio voltage VA1 and the second audio voltage VA2, it indicates that the driving frequency of the resonant power conversion circuit 100 falls within the audio frequency range. The detailed description of how the mapping voltage VIB is generated will be described in the following paragraphs.

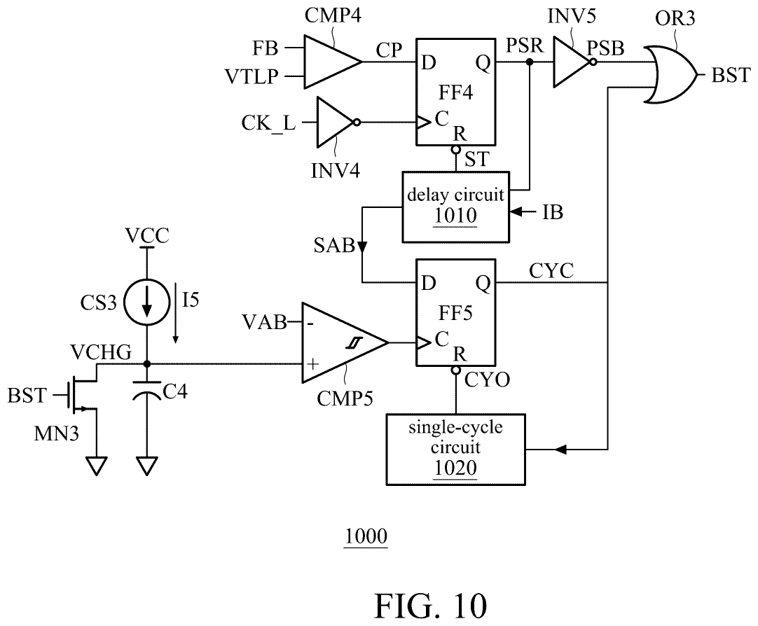

FIG. 10 shows a circuit diagram of an output voltage detection circuit in accordance with an embodiment of the present invention. According to one embodiment of the present invention, the control circuit 160 of FIG. 1 further includes an output voltage detection circuit 1000. As shown in FIG. 10, the output voltage detection circuit 1000 includes a fourth comparator CMP4, a fourth flip-flop FF4, a fourth inverter INV4, a fifth inverter INV5, a third OR gate OR3, a delay circuit 1010, a fifth flip-flop FF5, a third current source CS3, a fourth capacitor C4, a third N-type transistor MN3, a single-cycle circuit 1020, and a fifth comparator CMP5.

The fourth comparator CMP4 compares the feedback voltage FB with the low-power threshold voltage VTLP to generate a comparison signal CP. According to an embodiment of the present invention, when the output voltage VOUT in FIG. 1 increases, the feedback voltage FB decreases, and the increase in the output voltage VOUT indicates a decrease in output power. In other words, when the comparison signal CP in FIG. 10 is at a high logic level, it indicates that the output power is too low.

The fourth inverter INV4 inverts the low-side dead-time signal CK_L, triggering the fourth flip-flop FF4 to output the comparison signal CP as the pre-burst signal PSR, and the inverted pre-burst signal PSB is then generated via the fifth inverter INV5. In the embodiment of FIG. 10, the fourth flip-flop FF4 outputs the enabled comparison signal CP as the pre-burst signal PSR in response to the positive edge of the output signal of the fourth inverter INV4. Furthermore, when the reset signal ST is at a low logic level, the pre-burst signal PSR is reset to a disabled state.

After receiving the pre-burst signal PSR at a high logic level, the delay circuit 1010 delays by a delay time and generates a reset signal ST to reset the fourth flip-flop FF4 and disable the pre-burst signal PSR. According to some embodiments of the present invention, the delay circuit 1010 is configured to determine the enable time of the pre-burst signal PSR. In addition, the delay circuit 1010 generates an audio signal SAB based on the mapping current IB generated by the compensation circuit 400 in FIG. 4. According to some embodiments of the present invention, when the delay circuit 1010 determines that the driving frequency of the resonant power converter circuit 100 enters the audio range AR based on the mapping current IB, the delay circuit 1010 enables the audio signal SAB.

The third current source CS3 is configured to generate a fifth current I5. The fifth current I5 charges the fourth capacitor C4 to generate a charging voltage VCHG. The third N-type transistor MN3 discharges the fourth capacitor C4 based on the burst signal BST at the high logic level. When the charging voltage VCHG exceeds the audio voltage VAB, the fifth flip-flop FF5 outputs the audio signal SAB being enabled as the cyclic signal CYC based on the positive signal edge generated by the fifth comparator CMP5.

When the cyclic signal CYC is at the high logic level, the third OR gate OR3 sets the burst signal BST to the high logic level, thereby triggering the control circuit 500 of FIG. 5 to operate in a normal operation mode to generate the high-side driving signal HS and the low-side driving signal LS, thereby driving the high-side transistor 111 and the low-side transistor 112. Subsequently, the single-cycle circuit 1020 generates a cyclic output signal CYO based on the cyclic signal CYC, thereby resetting the fifth flip-flop FF5 to disable the cyclic signal CYC (i.e., setting it to the low logic level).

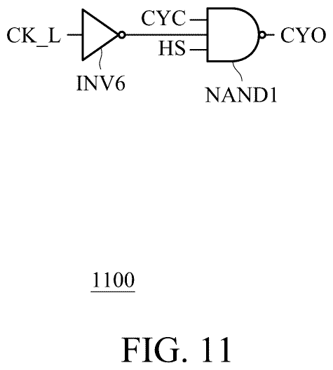

FIG. 11 shows a circuit diagram of a single-cycle circuit in accordance with an embodiment of the present invention. As shown in FIG. 11, the single-cycle circuit 1100 includes a sixth inverter INV6 and a first NAND gate NAND1. The sixth inverter INV6 inverts the low-side dead time signal CK_L, and the first NAND gate NAND1 performs a logical NAND operation on the cyclic signal CYC, the inverse of the low-side dead time signal CK_L, and the high-side driving signal HS to generate a cyclic output signal CYO.

As shown in FIG. 5, when the high-side driving signal HS is enabled and the first dead time generator DT1 generates a negative pulse on the low-side dead time signal CK_L, it indicates that the high-side transistor 111 is about to be turned off. In other words, when the cyclic signal CYC in FIG. 10 sets the burst signal BST to the high logic level via the third OR gate OR3, the control circuit 500 in FIG. 5 enables the low-side driving signal LS and the high-side driving signal HS, respectively. The single-cycle circuit 1100 in FIG. 11 then sets the burst signal BST to the low logic level synchronously when the high-side driving signal HS is disabled, based on the enabled cyclic signal CYC, the enabled high-side driving signal HS, and the negative pulse of the low-side dead time signal CK_L.

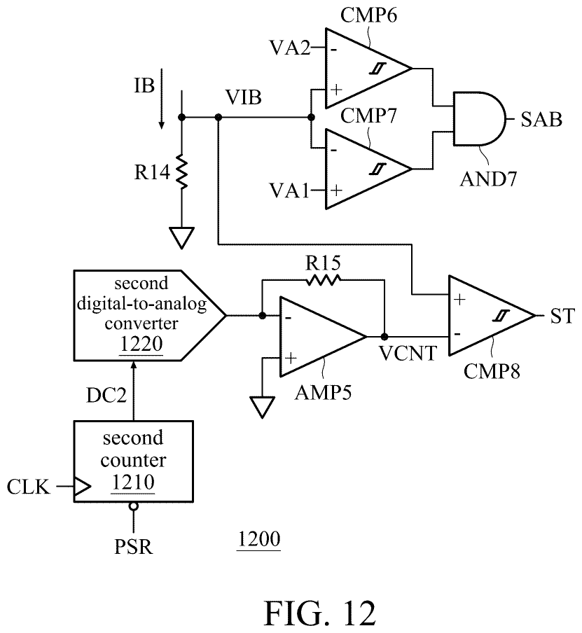

FIG. 12 shows a circuit diagram of a delay circuit in accordance with an embodiment of the present invention. As shown in FIG. 12, the delay circuit 1200 includes a fourteenth resistor R14, a sixth comparator CMP6, a seventh comparator CMP7, and a seventh AND gate AND7. A mapping current IB flows through the fourteenth resistor R14 to generate a mapping voltage VIB. The relationship between the mapping voltage VIB and the driving frequency of the resonant power conversion circuit 100 is shown in FIG. 9. The sixth comparator CMP6, the seventh comparator CMP7, and the seventh AND gate AND7 determine whether the driving frequency falls within the audio frequency range AR shown in FIG. 9 by determining whether the mapping voltage VIB is between the first audio voltage VA1 and the second audio voltage VA2, thereby generating the audio signal SAB.

According to an embodiment of the present invention, when it is determined that the driving frequency of the resonant power conversion circuit 100 has entered the audio frequency range AR shown in FIG. 9, the audio signal SAB is enabled, and the burst signal BST generated by the output voltage detection circuit 1000 in FIG. 10 is determined by the cyclic signal CYC. According to another embodiment of the present invention, when it is determined that the driving frequency of the resonant power conversion circuit 100 has not entered the audio frequency range AR shown in FIG. 9, the audio signal SAB is disabled. The burst signal BST generated by the output voltage detection circuit 1000 in FIG. 10 is determined by the pre-burst signal PSR.

As shown in FIG. 12, the delay circuit 1200 further includes a second counter 1210, a second digital-to-analog converter 1220, a fifth amplifier AMP5, a fifteenth resistor R15, and an eighth comparator CMP8. The second counter 1210 counts the second digital code DC2 based on the clock signal CLK, and the disabled pre-burst signal PSR is configured to reset the second digital code DC2 of the second counter 1210 to zero. The second digital-to-analog converter 1220 converts the second digital code DC2 into a voltage, which is then buffered by the fifth amplifier AMP5 and the fifteenth resistor R15 to generate a count voltage VCNT. The eighth comparator CMP8 compares the count voltage VCNT with the mapping voltage VIB to generate a reset signal ST.

According to some embodiments of the present invention, the second counter 1210, the second digital-to-analog converter 1220, the fifth comparator CMP5, the fifteenth resistor R15, and the eighth comparator CMP8 are configured to generate a delay time and reset the fourth flip-flop FF4 by disabling the reset signal ST. According to some embodiments of the present invention, the second counter 1210, the second digital-to-analog converter 1220, the fifth comparator CMP5, the fifteenth resistor R15, and the eighth comparator CMP8 are configured to determine the enable time of the pre-burst signal PSR.

In addition, since the mapping current IB changes with the feedback voltage FB, the mapping voltage VIB also changes accordingly. In other words, the delay time generated by the second counter 1210, the second digital-to-analog converter 1220, the fifth comparator CMP5, the fifteenth resistor R15, and the eighth comparator CMP8 increases as the mapping voltage VIB increases. In other words, as the mapping voltage VIB increases, the enable time of the pre-burst signal PSR also increases.

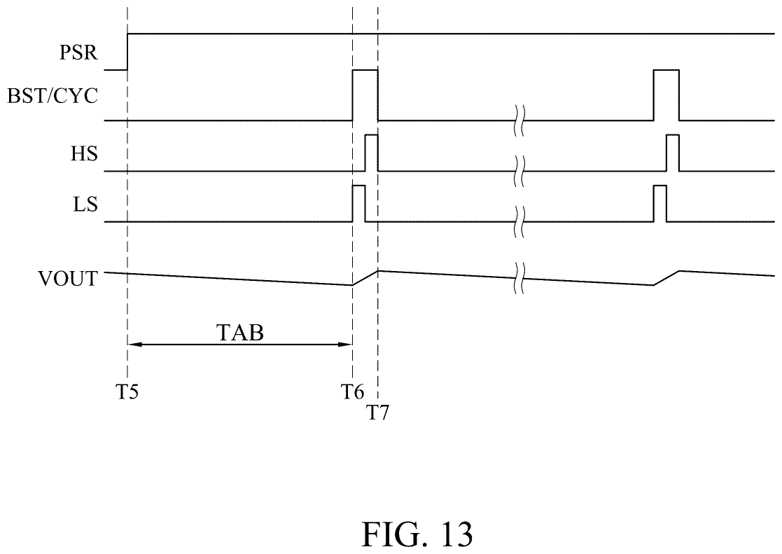

FIG. 13 shows waveforms of a resonant power conversion circuit operating in light load in accordance with another embodiment of the present invention. When the fourth comparator CMP4 in FIG. 10 determines that the feedback voltage FB drops below the low-power threshold voltage VTLP, the comparison signal CP in FIG. 10 is enabled, and the fourth flip-flop FF4 enables the pre-burst signal PSR at the fifth time point T5. According to some embodiments of the present invention, when the sixth comparator CMP6, the seventh comparator CMP7, and the seventh AND gate AND7 in FIG. 12 determine that the mapping voltage VIB is between the first audio voltage VA1 and the second audio voltage VA2, the audio signal SAB is enabled.

The third current source CS3, the fourth capacitor C4, and the fifth comparator CMP5 in FIG. 10 are configured to generate the audio delay time TAB shown in FIG. 13, and the fifth flip-flop FF5 in FIG. 10 enables the cyclic signal CYC at the sixth time point T6. According to some embodiments of the present invention, the audio delay time TAB is not less than the maximum value of the inverses of the audio frequencies. In other words, the period from the fifth time point T5 to the seventh time point T7 is greater than the audio period. In addition, the cyclic signal CYC sets the burst signal BST to the high logic level via the third OR gate OR3. As shown in FIG. 5, when the burst signal BST is at the high logic level, the control circuit 500 enables the low-side driving signal LS and then enables the high-side driving signal HS.

As shown in FIG. 11, after the low-side driving signal LS and the high-side driving signal HS are respectively enabled once between the sixth time point T6 and the seventh time point T7, the single-cycle circuit 1100 of FIG. 11 is configured to disable the cyclic signal CYC and to set the burst signal BST to the low logic level at the falling edge of the high-side driving signal HS (i.e., the seventh time point T7).

As shown in FIG. 8, since the high-side driving signal HS and the low-side driving signal LS are enabled several times when the burst signal BST is at the high logic level, it results in that the burst signal BST remains at the low logic level for a longer period, and thus the driving frequency of the resonant power conversion circuit 100 may enter the audio range. As shown in FIG. 13, since the high-side driving signal HS and the low-side driving signal LS are only enabled once when the burst signal BST is at the high logic level, the driving frequency of the resonant power conversion circuit 100 is increased, so as to prevent the driving frequency from the audio frequency range.

According to other embodiments of the present invention, in FIG. 11, the high-side driving signal HS and the low-side driving signal LS may be enabled more than once when the burst signal BST (or, the cyclic signal CYC) being at the high logic level. It is merely illustrated that the high-side driving signal HS and the low-side driving signal LS are only enabled once when the burst signal BST being at the high logic level, but not intended to be limited thereto. In other words, the high-side driving signal HS and the low-side driving signal LS each is enabled at least once when the burst signal BST (or, the cyclic signal CYC) being at the high logic level.

According to some embodiments of the present invention, when the output voltage VOUT generated by the cyclic signal CYC in FIG. 13 being enabled but cannot be fully consumed by the load, the first digital circuit 420 in FIG. 4 counts the number of times the cyclic signal CYC being enabled to gradually increase the circulating current ICYC, thereby increasing the mapping current IB to force the mapping voltage VIB to fall into the range between the first audio voltage VA1 and the second audio voltage VA2. Furthermore, as shown in FIG. 12, as the mapping voltage VIB increases, the enable time of the reset signal ST is also extended, thereby shifting the driving frequency outside the audio range AR.

According to some embodiments of the present invention, the fifth time point T5 to the seventh time point T7 constitutes a burst driving cycle, where the control circuit 160 determines the number of burst driving cycles to execute based on the length of the enable time of the pre-burst signal PSR. In other words, as the mapping voltage VIB increases, the number of burst driving cycles executed by the control circuit 160 increases accordingly.

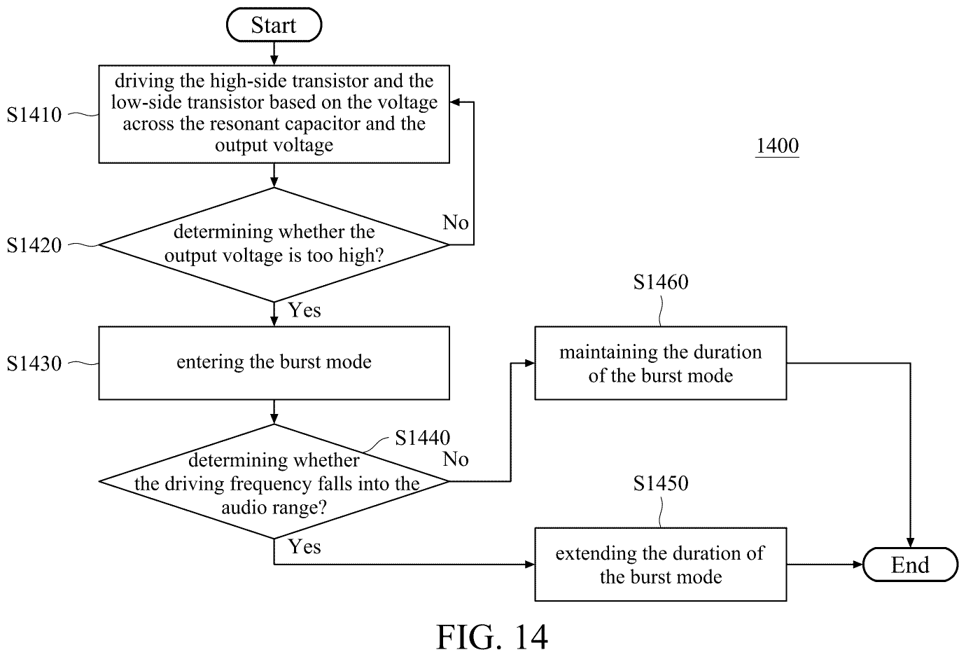

FIG. 14 shows a flow chart of a driving method in accordance with an embodiment of the present invention. In the driving method 1400, the high-side transistor 111 and the low-side transistor 112 are driven based on the voltage across the resonant capacitor CR and the output voltage VOUT (Step S1410). As shown in FIG. 1, the first current detection circuit 120 is configured to detect the current flowing through the resonant capacitor CR to generate a current detection signal CS, and the integrator 130 is configured to integrate the current detection signal CS to generate an integral signal INT. In other words, the first current detection circuit 120 and the integrator 130 are configured to detect the voltage across the resonant capacitor CR. Therefore, the full-wave rectification device 140 is configured to perform full-wave rectification on the voltage across the resonant capacitor CR to generate a rectified signal FW.

Next, as shown in FIG. 1, the feedback circuit 190 is configured to convert the output voltage VOUT into a feedback voltage FB. The compensation circuit 400 in FIG. 4 converts the feedback voltage FB into a compensation signal COMP. The control circuit 500 in FIG. 5 uses a second comparator CMP2 to compare the compensation signal COMP with the rectified signal FW to generate the high-side driving signal HS and the low-side driving signal LS for driving the high-side transistor 111 and the low-side transistor 112, respectively. In summary, the control circuit 160 drives the high-side transistor 111 and the low-side transistor 112 based on the voltage across the resonant capacitor CR and the output voltage VOUT.

Subsequently, it is determined whether the output voltage VOUT is too high (Step S1420). If the determination in Step S1420 is yes, the burst mode is entered (Step S1430). As shown in FIG. 10, the output voltage detection circuit 1000 determines whether the feedback voltage FB drops below the low-power threshold voltage VTLP. When the feedback voltage FB drops below the low-power threshold voltage VTLP, the output voltage detection circuit 1000 enables the pre-burst signal PSR and the burst signal BST (i.e., the low logic level), thereby entering the burst mode. According to some embodiments of the present invention, the feedback voltage FB drops as the output voltage VOUT increases or the output power of the output voltage VOUT decreases. As shown in FIG. 5, when the burst signal BST is at the low logic level (i.e., in the burst mode), both the high-side driving signal HS and the low-side driving signal LS are disabled, thereby simultaneously turning off the high-side transistor 111 and the low-side transistor 112.

When Step S1420 is determined to be negative, Step S1410 is executed again. According to some embodiments of the present invention, Step S1410 is the normal operation mode. After Step S1430, it is determined whether the driving frequency of the resonant power conversion circuit 100 enters the audio range (Step S1440). The relationship between the mapping voltage VIB generated by the delay circuit 1200 in FIG. 12 and the driving frequency is shown in FIG. 9. The delay circuit 1200 determines whether the driving frequency enters the audio range AR based on whether the mapping voltage VIB is between the first audio voltage VA1 and the second audio voltage VA2.

When the determination in Step S1440 is yes, the duration of the burst mode is extended (Step S1450). As shown in FIG. 12, when the mapping voltage VIB is between the first audio voltage VA1 and the second audio voltage VA2, the delay circuit 1200 enables the audio signal SAB. Based on the audio signal SAB being enabled, the output voltage detection circuit 1000 in FIG. 10 enables the cyclic signal CYC and sets the burst signal BST to the high logic level after the audio delay time TAB. When the burst signal BST is at the high logic level, the control circuit 500 of FIG. 5 enables the high-side driving signal HS and the low-side driving signal LS, respectively.

According to some embodiments of the present invention, the audio delay time TAB is generated by the third current source CS3, the fourth capacitor C4, and the fifth comparator CMP5, where the audio delay time TAB is not less than the audio period. Specifically, as shown in FIG. 9, the maximum audio period of the audio range AR is the inverse of the first frequency F1. The audio delay time TAB is not less than the inverse of the first frequency F1. In the embodiment of FIG. 13, the burst mode duration is equal to the audio delay time TAB, and therefore the driving frequency of the resonant power conversion circuit 100 is less than the audio range AR.

When Step S1440 is determined to be no, the duration of the burst mode is maintained (Step S1460). According to some embodiments of the present invention, the duration of the burst mode in Step S1460 is determined by the clock signal CLK, the second counter 1210, and the second digital-to-analog converter 1220 in FIG. 12, and the burst mode in Step S1460 is shown in FIG. 8. According to some embodiments of the present invention, the duration of the burst mode in Step S1460 is less than the audio delay time TAB. Specifically, the burst period TBST in FIG. 8 is less than the audio delay period TAB in FIG. 13.

The present invention proposes a resonant power converter circuit and a driving method thereof, which determines whether the burst frequency of the resonant power conversion circuit enters the audio range by monitoring a mapping voltage related to the feedback voltage. When it is determined that the burst frequency of the resonant power conversion circuit enters the audio range, the duration that both the high-side transistor and the low-side transistor are turned off is extended, so that the driving frequency leaves the audio range, thereby eliminating the noise generated by the resonant power conversion circuit.

Although some embodiments of the present disclosure and their advantages have been described in detail, it should be understood that various changes, substitutions and alterations can be made herein without departing from the spirit and scope of the disclosure as defined by the appended claims. For example, it will be readily understood by those skilled in the art that many of the features, functions, processes, and materials described herein may be varied while remaining within the scope of the present disclosure. Moreover, the scope of the present application is not intended to be limited to the particular embodiments of the process, machine, manufacture, composition of matter, means, methods and steps described in the specification. As one of ordinary skill in the art will readily appreciate from the disclosure of the present disclosure, processes, machines, manufacture, compositions of matter, means, methods, or steps, presently existing or later to be developed, that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A resonant power conversion circuit converting an input voltage into an output voltage, comprising:
a resonant capacitor, coupled between a resonant node and a ground;
a transformer, comprising a primary coil and a secondary coil, wherein the primary coil is coupled between a switch node and the resonant node;
a high-side transistor, providing the input voltage to the switch node based on a high-side driving signal;
a low-side transistor, coupling the switch node to the ground based on a low-side driving signal; and
a control circuit, generating the high-side driving signal and the low-side driving signal based on the output voltage;
wherein when the control circuit determines that a driving frequency of either the high-side driving signal or the low-side driving signal enters a frequency range, the control circuit simultaneously turns off both the high-side transistor and the low-side transistor for a delay time, so as to shift the driving frequency outside the frequency range.

2. The resonant power conversion circuit as claimed in claim 1, further comprising:
a feedback circuit, generating a feedback voltage based on the output voltage;
wherein the control circuit further comprises:
a compensation circuit, generating a compensation voltage based on the feedback voltage and subtracting a sawtooth wave from the compensation voltage to generate a compensation signal;
wherein when the feedback voltage is less than a feedback threshold voltage, the compensation voltage is equal to the feedback threshold voltage;
wherein when the feedback voltage is not less than the feedback threshold voltage, the compensation voltage is equal to the feedback voltage.

3. The resonant power conversion circuit as claimed in claim 2, wherein the compensation circuit further comprises:
a first amplifier, comprising a first positive input terminal, a first negative input terminal, and a first output terminal, wherein the first positive input terminal receives the feedback voltage, and the first negative input terminal is coupled to the first output terminal;
a second amplifier, comprising a second positive input terminal, a second negative input terminal, and a second output terminal, wherein the second positive input terminal receives the feedback threshold voltage, and the second output terminal generates the compensation voltage;
a resistor, coupled between the second negative input terminal and the first output terminal and generating a difference current;
an N-type transistor, comprising a gate terminal, a drain terminal, and a source terminal, wherein the gate terminal is coupled to the second output terminal, and the source terminal is coupled to the second negative input terminal;
a digital circuit, sinking a circulating current from the drain terminal;
a current mirror, mirroring a sum of the difference current and the circulating current to a mapping current; and
a summing circuit, subtracting the sawtooth wave from the compensation voltage to generate the compensation signal.

4. The resonant power conversion circuit as claimed in claim 2, further comprising:
a first current detection circuit, detecting a current flowing through the resonant capacitor to generate a current detection signal;
an integrator, integrating the current detection signal to generate an integral signal;
a full-wave rectification device, full-wave rectifying the integral signal generated by the integrator to generate a rectified signal; and
a regulation circuit, coupled to the secondary coil and converting a current flowing through the secondary coil into the output voltage;
wherein the control circuit generates the high-side driving signal and the low-side driving signal based on a relationship between the compensation signal and the rectified signal.

5. The resonant power conversion circuit as claimed in claim 2, wherein the control circuit further comprises:
an output voltage detection circuit, determining whether the feedback voltage is less than a low-power threshold voltage to generate a pre-burst signal;
wherein when the feedback voltage is less than the low-power threshold voltage, the output voltage detection circuit enables the pre-burst signal;
wherein when the feedback voltage is not less than the low-power threshold voltage, the output voltage detection circuit disables the pre-burst signal.

6. The resonant power conversion circuit as claimed in claim 5, wherein the control circuit simultaneously disables both the high-side driving signal and the low-side driving signal based on the pre-burst signal being enabled, so as to lower the driving frequency;
wherein the control circuit enables the high-side driving signal and the low-side driving signal individually based on the pre-burst signal being disabled.

7. The resonant power conversion circuit as claimed in claim 5, wherein when the feedback voltage is less than the low-power threshold voltage, the output voltage detection circuit further determines whether the driving frequency enters the frequency range;
wherein when the driving frequency enters the frequency range, the control circuit enables a cyclic signal to simultaneously turn off both the high-side transistor and the low-side transistor for an audio-frequency delay time;
wherein after the audio-frequency delay time, the control circuit respectively enables the high-side driving signal and the low-side driving signal each at least once.

8. The resonant power conversion circuit as claimed in claim 7, wherein the frequency range is a range of audio frequencies;
wherein the audio-frequency delay time is not less than a maximum of inverses of the audio frequencies.

9. The resonant power conversion circuit as claimed in claim 7, wherein the compensation circuit generates a mapping voltage based on a difference of the feedback threshold voltage minus the feedback voltage;
wherein the output voltage detection circuit determines, based on the mapping voltage being between a first audio voltage and a second audio voltage, that the driving frequency enters the frequency range;
wherein the mapping voltage is configured to determine a duration that the pre-burst signal is enabled.

10. The resonant power conversion circuit as claimed in claim 9, wherein the compensation circuit increases the mapping voltage based on a number of times that the cyclic signal is enabled, so as to extend the duration that the pre-burst signal is enabled.

11. A driving method for driving a resonant power conversion circuit, wherein the driving method comprises:
driving a high-side transistor and a low-side transistor of the resonant power conversion circuit based on a voltage across a resonant capacitor and an output voltage of the resonant power conversion circuit;
determining whether the output voltage of the resonant power conversion circuit is too high;
when it is determined that the output voltage is too high, entering a burst mode;
determining whether a driving frequency of the resonant power conversion circuit falls into an audio range; and
when it is determined that the driving frequency falls into the audio range, extending a duration of the burst mode.

12. The driving method as claimed in claim 11, wherein the resonant power conversion circuit comprises the resonant capacitor coupled between a resonant node and the ground, a transformer comprising a primary coil and a secondary coil, the high-side transistor providing an input voltage to a switch node, and the low-side transistor coupling the switch node to the ground;
wherein the primary coil is coupled between the switch node and the resonant node.

13. The driving method as claimed in claim 11, wherein the step of driving the high-side transistor and the low-side transistor of the resonant power conversion circuit based on the voltage across the resonant capacitor and the output voltage of the resonant power conversion circuit further comprises:
full-wave rectifying the voltage across the resonant capacitor to generate a rectified signal;
generating a compensation voltage based on the feedback voltage;
subtracting a sawtooth wave from the compensation voltage to generate a compensation signal; and
comparing the rectified signal to the compensation signal to drive the high-side transistor and the low-side transistor;
wherein when the feedback voltage is less than a feedback threshold voltage, the compensation voltage is equal to the feedback threshold voltage;
wherein when the feedback voltage is not less than the feedback threshold voltage, the compensation voltage is equal to the feedback voltage.

14. The driving method as claimed in claim 13, wherein the step of full-wave rectifying the voltage across the resonant capacitor to generate a rectified signal further comprises:
detecting a current flowing through the resonant capacitor to generate a current detection signal;
integrating the current detection signal to generate an integral signal; and
full-wave rectifying the integral signal to generate the rectified signal.

15. The driving method as claimed in claim 13, wherein the step of determining whether the output voltage of the resonant power conversion circuit is too high further comprises:
determining whether the feedback is less than a low-power threshold voltage;
when the feedback voltage is less than the low-power threshold voltage, entering the burst mode; and
when the feedback voltage is not less than the low-power threshold voltage, not entering the burst mode;
wherein both the high-side transistor and the low-side transistor are turned off simultaneously in the burst mode.

16. The driving method as claimed in claim 13, wherein the step of determining whether the driving frequency of the resonant power conversion circuit falls into the audio range further comprises:
generating a mapping voltage based on the feedback voltage;
determining whether the mapping voltage is between a first audio voltage and a second audio voltage;
when the mapping voltage is between the first audio voltage and the second audio voltage, determining that the driving frequency of the resonant power conversion circuit falls into the audio range; and
when the mapping voltage is outside the first audio voltage and the second audio voltage, determining that the driving frequency of the resonant power conversion circuit does not fall into the audio range.

17. The driving method as claimed in claim 16, wherein the step of generating the mapping voltage based on the feedback voltage further comprises:
generating a difference current based on a difference of the feedback threshold voltage minus the feedback voltage;
mapping the difference current to a mapping current using a current mirror; and
generating the mapping voltage using the mapping current flowing through a resistor.

18. The driving method as claimed in claim 16, wherein when it is determined that the driving frequency falls into the audio range, the duration of the burst mode is extended to an audio-frequency delay time;
wherein after the audio-frequency delay time, turning on the high-side transistor and the low-side transistor each at least once.

19. The driving method as claimed in claim 18, wherein the audio-frequency delay time is not less than a maximum of inverses of audio frequencies.

20. The driving method as claimed in claim 18, further comprising:
determining number of times that the burst mode and a cyclic signal have been enabled based on a duration that a pre-burst signal is enabled;
counting the number of times that the cyclic signal has been enabled; and
extending the duration of the pre-burst signal being enabled based on the number of times that the cyclic signal has been enabled.
